(19) United States
(12) Patent Application Publication
(10) Pub. No.: US 2025/0381831 A1
(43) Pub. Date: Dec. 18, 2025

(54) PERFECTED BATTERY FOR VEHICLES, KIT AND METHOD FOR THE CONVERSION OF AN ENDOTHERMIC VEHICLE TO A HYBRID VEHICLE

(71) Applicant: NEWTRON GROUP SA, LUGANO (CH)

(72) Inventor: Nicola VENUTO, LUGANO (CH)

(21) Appl. No.: 19/222,554

(22) Filed: May 29, 2025

(30) Foreign Application Priority Data
Jun. 14, 2024 (IT) 102024000013729

(51) Int. Cl. B60K 6/28; B60K 6/48; B60S 5/06; B60W 10/08; B60W 20/10; H01M 10/42; H01M 10/46; H01M 50/249

(52) U.S. Cl. CPC B60K 6/28; B60K 6/48; B60S 5/06; B60W 10/08; B60W 20/10; H01M 10/4264; H01M 10/46; H01M 50/249; B60W 2510/0638; B60W 2530/18; B60W 2710/083; B60W 2710/1022; B60Y 2200/92; B60Y 2300/188; B60Y 2300/60; B60Y 2400/112; B60Y 2400/114; B60Y 2400/43; B60Y 2400/60; B60Y 2400/61; H01M 2220/20

(57) ABSTRACT

The present invention relates to a perfected battery (1) for vehicles, comprising:
a housing (2) bounded by a cover (3) and configured to receive inside:
   a battery pack (4) configured to store electrical energy and power a motor-alternator (8) of said vehicle, and
   a service battery (5) in electrical communication with said motor-alternator (8) and configured to:
      store electrical energy, and
      power the services of the vehicle,
an inverter (6) configured to:
   put said batteries (5, 6) and said motor-alternator (8) in electrical communication with each other,
   regulate the delivery of electrical energy from said battery pack (4) to said motor-alternator (8) so that the latter exerts a predefined driving torque on a transmission of the vehicle.

### TECHNICAL FIELD

The present invention relates to a perfected battery which can be connected to a vehicle for the replacement of an original battery or also for the electric conversion of a heat engine vehicle. Specifically, the perfected battery is insertable within the battery compartment of the vehicle.

### BACKGROUND ART

Hybrid electric cars, and hybrid vehicles in general, are known in the state of the art. To be called a hybrid a car must have a pair of motors of which one is a heat engine and the other is an electric motor.

It should be specified that every hybrid electric car always comprises two batteries: a battery pack associated with the electric motor to power it and a service battery to power all the services of the vehicle which do not contribute to the motorization of the same.

Hybrid electric cars can be divided into different categories, such as mild hybrid cars (MHEV), full hybrid cars (HEV) and plug-in hybrid cars (PHEV).

In MHEV cars, the electric motor and its battery pack are limited in size and power. The electric motor in MHEV cars always operates in conjunction with the heat engine by assisting it when switching on, starting and accelerating. The electric motor, therefore, provides additional driving torque to the heat engine to lighten the work thereof at times of greatest effort thus allowing it to consume less fuel and optimize emissions. MHEV cars generally have a 12-, 24- or 48-V battery pack which is recharged solely from the energy recovered during deceleration and braking.

In HEV cars, the power of the electric motor and its battery pack is greater than in MHEV cars. In fact, the electric motor and the battery pack offer the possibility of obtaining the car's motion in a fully electric manner, that is, even without the heat engine being in operation. As with MHEV cars, the battery pack in HEV cars can also be recharged only under braking, during vehicle deceleration or by employing power delivered by the heat engine.

Finally, PHEV cars are quite similar to HEV cars and feature an electric motor and a battery pack that allow the vehicle to move in electric-only mode without employing the heat engine. Unlike HEV cars, the battery pack of PHEV cars can be recharged directly through its connection to the power grid, e.g. by means of a household outlet or charging station.

One characteristic shared by all three types of hybrid cars is the separation of the battery pack from the service battery. In fact, the two batteries are separate from each other and installed on the vehicle at spaced apart locations. The battery pack is usually located in the proximity of the underbody of the vehicle while the service battery is within the engine compartment.

The Applicant has found that it is possible to reduce the overall dimensions of the enclosures containing the battery pack and the service battery in hybrid vehicles by making a perfected battery adapted to power both the vehicle's services and the electric motor installed on the vehicle at a single location.

Systems and procedures are also known in the state of the art which allow the conversion of endothermic vehicles to PHEV, HEV, or MHEV hybrid vehicles. These procedures first involve coupling an electric motor to the original heat engine, generally, by connecting it directly to the vehicle's transmission. The known procedure then involves implementing major structural changes to the vehicle so that it is possible to install a suitable battery connected to the electric motor and related control devices, e.g. a control unit to control the electric motor. Therefore, the known systems and procedures to convert a heat engine vehicle to a hybrid vehicle require a plurality of modifications to the vehicle such that re-approval of the vehicle is required following conversion.

The Applicant has found that it is possible to convert a vehicle to a hybrid vehicle by reducing the number and amplitude of modifications to the vehicle, while maintaining and improving the original performance of the vehicle and, therefore, without requiring subsequent re-approval. Specifically, the Applicant has found that it is possible to convert an endothermic vehicle to a MHEV hybrid vehicle by employing such a perfected battery.

### DESCRIPTION OF THE INVENTION

The Applicant has thus thought to overcome these drawbacks by offering a perfected battery and a relevant kit comprising it, which can be installed in the vehicle quite easily and quickly and which encloses in a reduced space both the battery pack needed to operate the electric motor and the service battery to power the vehicle's services.

A further object of the present invention is to provide a perfected battery which enables smart control of a motor-alternator and/or of the electric motor of the vehicle to which it is connected.

Furthermore, the present invention also aims at offering a battery and a kit for the electric conversion of an endothermic vehicle which allows a vehicle provided with an endothermic engine to be made hybrid with a small number of modifications to the vehicle.

A further object of the invention is to provide a method for the conversion of a heat engine vehicle to a hybrid vehicle by replacing a small number of original components of the vehicle.

A further object of the invention is to provide a perfected battery, a kit and a method for the electric conversion of a heat engine vehicle which enable a hybrid vehicle to be obtained without the need to re-approve the vehicle following conversion.

The aforementioned objects are achieved by the perfected battery according to claim 1.

The objects are also achieved by the kit for the conversion of an endothermic vehicle to a hybrid vehicle according to claim 8 and by the related method according to claim 9.

### BRIEF DESCRIPTION OF THE DRAWINGS

Some embodiments and aspects of the invention will be described below with reference to the attached drawings, provided for illustrative purposes only and therefore not limiting, wherein:

FIG. 1 shows a block diagram of the perfected battery in accordance with this invention;

FIG. 2 is a perspective view of the perfected battery in accordance with this description with some elements concealed to better show others;

FIG. 3 shows a perspective view of a detail of the battery in FIG. 2;

FIG. 4 is a side perspective view of the battery in FIG. 2;

FIG. 5 shows a view from above of the battery in FIG. 2;

FIG. 6 is an exploded view of a battery in accordance with this invention.

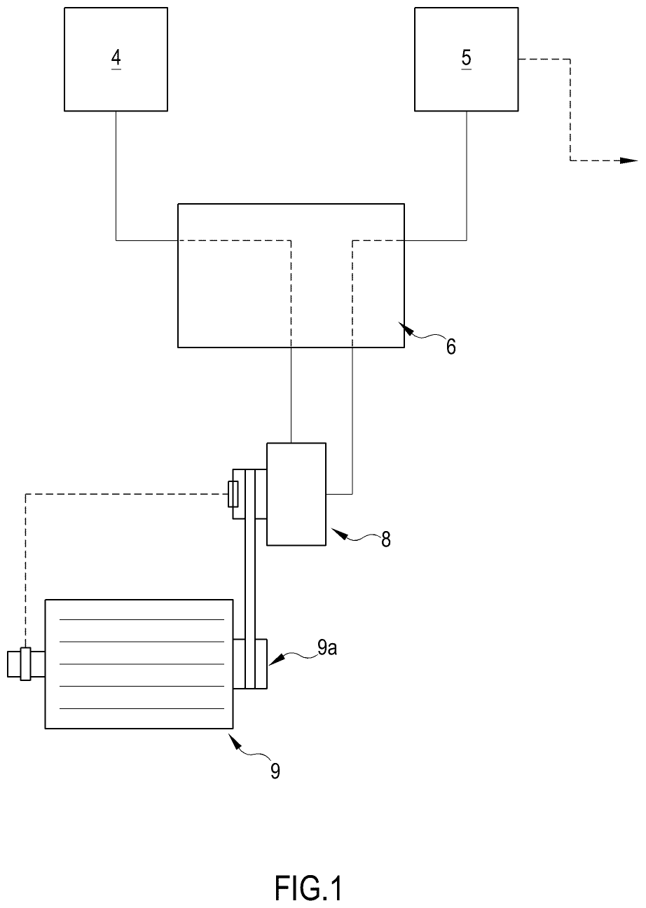

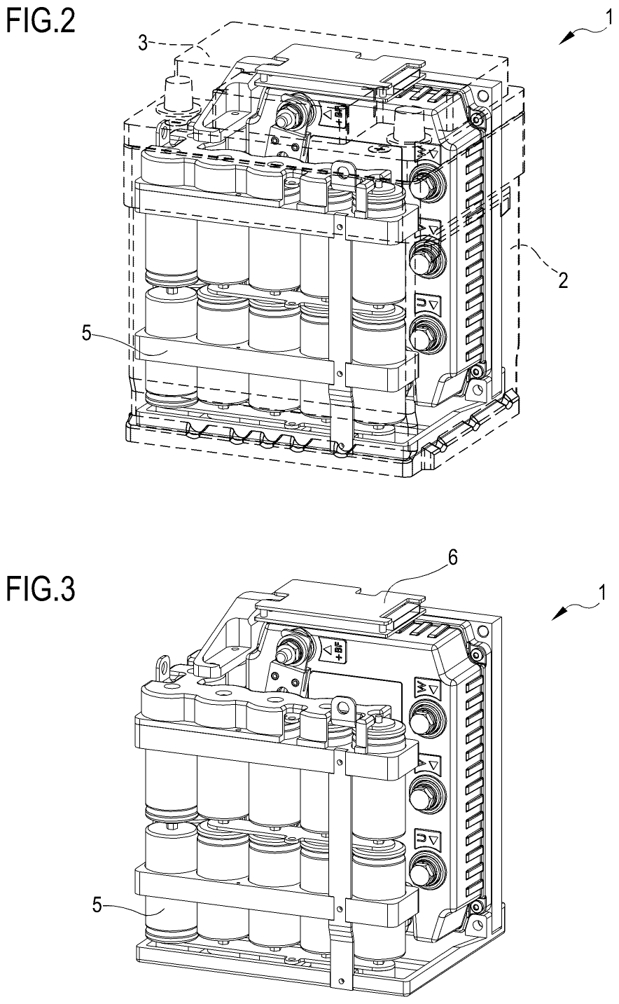

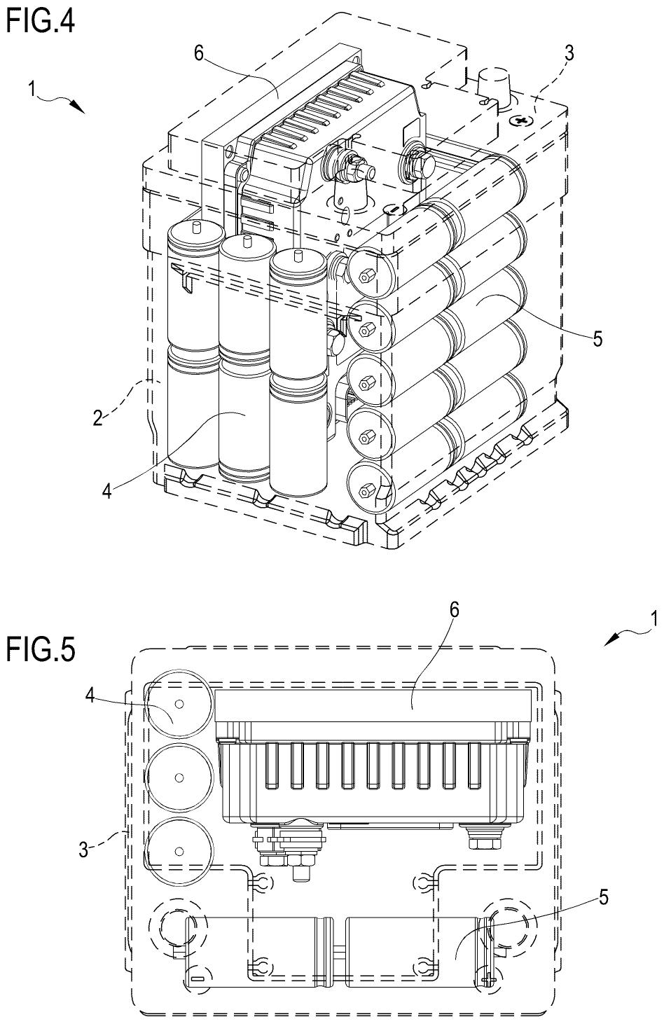

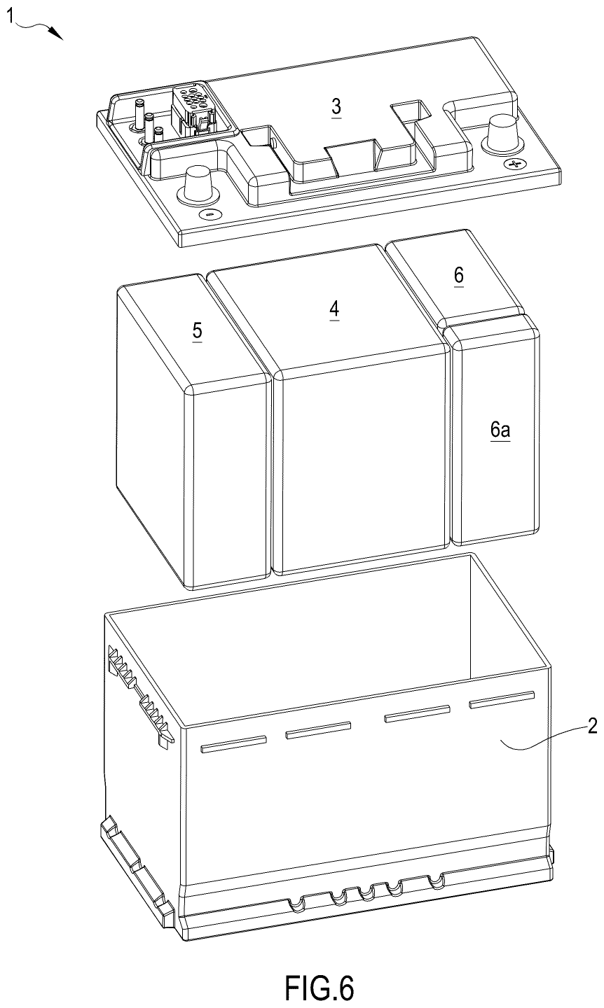

### EMBODIMENTS OF THE INVENTION

This description relates to a perfected battery 1 for vehicles, particularly for hybrid vehicles which are provided with an electric motor or motor-alternator 8 or for endothermic vehicles provided with an alternator which can be replaced with a motor-alternator 8.

The perfected battery 1 comprises a housing 2 bounded by a cover 3. The housing 2 is configured to receive a battery pack 4 and a service battery 5 inside. The housing 2 has a parallelepiped shape. The housing 2 is substantially defined by an enclosure or shell, preferably made of plastic material. The cover 3 is provided with poles configured to be set in electrical connection with the service battery 5. The poles of the cover 3 comprise a positive pole and a negative pole.

Specifically, the battery pack 4 is configured to store electrical energy and power a motor-alternator 8 of the vehicle. The battery pack 4 is configured to supply electrical energy to the motor-alternator 8 for the operation thereof. The battery pack 4 is adapted to supply electrical energy to the motor-alternator 8 to move the vehicle. Specifically, the battery pack is sized so as to allow the vehicle to be moved in a fully electric manner, that is, even without the heat engine 9 being driven and running. In one embodiment, the battery pack 4 can also provide electrical energy to the services of the vehicle.

The service battery 5 is in electrical communication with the vehicle's services and with the vehicle's motor-alternator 8, in particular, exclusively to be charged. The service battery 5 is configured to store the electrical energy received from the motor-alternator 8 and to supply such an electrical energy to the vehicle's services. The term “vehicle's services” refers to the energy accumulators comprised in the vehicle, such as e.g. heating fans, water pump and in general anything that does not control the vehicle's starting.

In detail, the service battery 5 is not configured to supply electrical energy to the motor-alternator 8. In fact, in the preferred embodiment, the service battery 5 does not power the motor-alternator 8 but only the vehicle's services. The motor-alternator 8 of the vehicle is substantially adapted to charge the service battery 5. Specifically, when the motor-alternator 8 has the function of alternator, such motor-alternator 8 supplies electrical energy to the service battery 5 so that at least part of the electrical energy supplied by the motor-alternator 8 is stored within such service battery 5.

In one embodiment, the battery pack 4 and the service battery 5 are made into just one battery configured to supply electrical energy to both the motor-alternator 8 and the vehicle's services. In fact, it is possible to make a perfected battery 1 wherein the battery pack 4 and the service battery 5 are separate or, conversely, wherein the battery pack 4 and the service battery 5 are combined into just one battery. The battery pack 4 and the service battery 5 may both power the vehicle's services.

The perfected battery 1 also comprises an inverter 6 which is adapted to set the battery pack 4, the service battery 5 and the motor-alternator 8 of the vehicle in electrical communication. In fact, the inverter 6 is adapted to set the battery pack 4 in electrical communication with the motor-alternator 8 so that the latter can receive/supply electrical energy from/to the battery pack 4. In addition, the inverter sets the motor-alternator 8 and the service battery 5 in electrical communication so that the latter receives the electrical energy from the motor-alternator 8. In detail, the motor-alternator 8 has the function of electric motor when the battery pack 4 supplies electrical energy to such motor-alternator 8. The motor-alternator 8 has the function of alternator when it supplies the electrical energy to the battery pack 4 and/or to the service battery 5.

Specifically, the inverter 6 is configured to regulate the delivery of electrical energy from the battery pack 4 to the motor-alternator 8 so that such motor-alternator 8 exerts a predefined driving torque on a transmission of the vehicle, e.g. by means of the crankshaft 9a of the heat engine 9.

In addition, the inverter 6 is configured to regulate the delivery of electrical energy from the motor-alternator 8 to the battery pack 4 and/or to the service battery 5 so that such electrical energy supplied by the motor-alternator 8 may be stored within the battery pack and/or within the service battery 5 and available for later use. Specifically, the inverter 6 is configured to allow the motor-alternator 8 to supply electrical energy to the service battery and/or to the battery pack when the vehicle is under braking so that it is possible to convert the kinetic energy of the vehicle to electrical energy through the motor-alternator 8.

According to one aspect, the inverter 6 is configured to detect the torque data of the heat engine 9 of the vehicle through the motor-alternator 8. In detail, the motor-alternator 8 is configured to have the function of dynamometer bench to detect the driving torque of the heat engine 9 when the heat engine 9 is running. The torque data of the heat engine 9 comprise the driving torque values generated by the heat engine 9 and the number of revolutions associated with each of these driving torque values. Through the torque data of the heat engine 9, a maximum driving torque value generated by the heat engine 9 can be identified. Specifically, the torque data of the heat engine 9 comprise a torque curve of the heat engine 9.

It is known in the prior art that the maximum torque value of the heat engine 9 is useful for sizing the vehicle components downstream of the heat engine 9, and therefore, this value is a fundamental parameter associated with the vehicle.

In addition, the inverter 6 is configured to regulate the delivery of electrical energy to the motor-alternator 8 depending on the maximum driving torque of the heat engine 9. Specifically, the inverter 6 is configured to regulate the delivery of electrical energy to the motor-alternator 8 in such a way that the driving torque generated by the motor-alternator 8, alone or added to the driving torque generated by the heat engine 9, is not greater than the maximum driving torque of the heat engine 9 depending on which the vehicle has been approved and sized in its components. In other words, the inverter regulates the delivery of electrical energy to the motor-alternator 8 so that the driving torque generated by the motor-alternator 8 is limited depending on the original characteristics of the vehicle.

Advantageously, regulating the driving torque generated by the motor-alternator 8 depending on the maximum driving torque of the electric motor, and therefore depending on the characteristics of the vehicle, makes it possible to convert a heat engine vehicle to a hybrid vehicle without the need for re-approval for such a vehicle.

The inverter 6 can also be configured to detect the instantaneous driving torque exerted by the heat engine 9 on the transmission of the vehicle and of the number of revolutions associated with the heat engine 9. The inverter 6 and/or the motor-alternator 8 enable the detection of the driving torque generated by the heat engine 9 instantaneously when the heat engine 9 is running.

In one embodiment, the inverter 6 is configured to determine the predefined driving torque of the motor-alternator 8 as the difference between the maximum driving torque and the instantaneous driving torque exerted by the heat engine 9.

The predefined driving torque of the motor-alternator 8 is calculated as the difference between the maximum driving torque and the instantaneous driving torque exerted by the heat engine 9. The predefined driving torque of the motor-alternator 8 is equal to or less than the difference between the maximum driving torque and the instantaneous driving torque of the heat engine 9.

In fact, the inverter is configured to supply energy to the motor-alternator 8 so that the sum of the instantaneous driving torque of the heat engine 9 and of the predefined driving torque of the motor-alternator 8 is equal to or less than the maximum driving torque of the heat engine 9.

The inverter 6 is also configured to regulate the delivery of electrical energy to the motor-alternator 8 depending on the predefined driving torque and on the number of revolutions associated with the heat engine 9. According to one aspect, the inverter 6 is configured to regulate the supply of electrical energy to the motor-alternator 8 depending on the number of revolutions of the heat engine 9.

In other words, the inverter 6 is configured to regulate the operation of the motor-alternator 8 depending on three parameters: the number of revolutions, the maximum driving torque and the instantaneous driving torque of the heat engine 9 of the vehicle.

The inverter 6 is configured to detect the torque data of the heat engine 9 for a predefined length of time or for a predefined distance traveled by the vehicle.

Preferably, the predefined distance is 50 km or more. The motor-alternator 8 is configured to operate as dynamometer bench for a predefined length of time or for a predefined distance traveled by the vehicle moved by the heat engine 9 only.

The inverter 6 is configured to acquire the torque data from the heat engine 9, to detect/determine the maximum driving torque, the instantaneous driving torque and the number of revolutions for such length of time or predefined distance. The predefined distance traveled by the vehicle can be 50 km, 100 km or greater than 100 km.

The inverter 6 is configured to acquire the torque data from the heat engine 9 through the motor-alternator 8 and to store the torque data from the heat engine 9 to make an archive. The archive comprises the generated driving torque values of the heat engine 9 associated with a respective number of revolutions. In other words, the archive comprises values representative of a motor curve, also called a characteristic curve, of the heat engine 9. Such a motor curve represents the ratio existing between the driving torque generated by the heat engine 9 of the vehicle available at the crankshaft and the corresponding angular speed.

According to one aspect, the battery pack 4 comprises at least one supercapacitor 7 to store energy and to power the motor-alternator 8. In one embodiment, the supercapacitors 7 are six in number. The supercapacitor is configured to store an amount of electrical energy and to supply such electrical energy to the motor-alternator in a controlled manner.

In one embodiment, the battery pack 4 supplies a voltage equal to 12V. In detail, the battery pack 4 supplies an inrush current of between 800 A and 1300 A. In more detail, the inrush current of the battery pack 4 can take any of the values: 800 A; 975 A; 1140 A; 1200 A; 1275 A; 1300 A.

The service battery 5 supplies a voltage of between 12 V and 48 V. In detail, the service battery 5 may have a capacity of between 40 Ah and 250 Ah. The service battery 5 supplies an inrush current between 500 Ah and 850 A. The capacity of the service battery can take any of the values: 40 Ah; 45 Ah; 50 Ah; 55 Ah; 60 Ah; 70 Ah; 80 Ah; 95 Ah; 110 Ah. The inrush current of the service battery can take any of the values: 400 A; 500 A; 650 A; 760 A; 800 A; 850 A.

In one embodiment, the housing 2 has a width of 175 mm, a height of 190 mm and a depth of between 200 mm and 400 mm. The depth of the housing 2 can take any of the values: 200 mm, 207 mm, 242 mm, 275 mm, 278 mm, 310 mm, 315 mm, 353 mm, 394 mm. In other words, the housing 2 of the perfected battery can be substantially the same size as the size of the service batteries commonly installed on known vehicles so that the perfected battery can be advantageously installed on the vehicle quickly and easily in the engine compartment of the vehicle itself.

According to one aspect, the inverter 6 comprises a connection interface 6a for connecting the perfected battery 1 to the vehicle's electrical system. The connection interface 6a is defined by an Electronic Control Unit or ECU. Specifically, the inverter 6 is associable with a CAN network of the vehicle through the ECU. Thus, the perfected battery 1 is an independent technical unit installable on the vehicle and able to communicate with the services of such vehicle.

This description also relates to a kit for the conversion of an endothermic vehicle to a hybrid vehicle.

The kit comprises a motor-alternator 8 couplable to the heat engine 9 of the vehicle and configured to exert a predefined driving torque on a transmission of the vehicle, e.g. through the crankshaft 9a of the heat engine 9.

The kit also comprises a perfected battery 1 in accordance with this description. Specifically, the perfected battery 1 is in electrical communication with such motor-alternator 8.

Advantageously, the motor-alternator 8 of the kit is structurally similar to a known alternator installed on known vehicles so that such a known alternator can be easily and quickly replaced with the motor-alternator 8 of the kit.

The present description also relates to a method for the conversion of an endothermic vehicle to a hybrid vehicle which comprises the phase of replacing an original battery of the vehicle with the perfected battery 1 of the present invention. In other words, the method involves removing the original service battery of the vehicle and installing the perfected battery at the same location originally prepared for the service battery of the vehicle.

The method comprises the phase of replacing an original alternator of the vehicle with a motor-alternator 8 associable with the heat engine 9 and with the perfected battery. The motor-alternator 8 is configured to exert a respective driving torque on a transmission of the vehicle. The motor-alternator 8 is coupled to the inverter and in electrical communication with the battery pack and the service battery 5 to supply and/or receive electrical energy.

The method involves removing the original alternator from the vehicle and installing the motor-alternator 8 on the vehicle in the compartment where the original alternator was installed.

The method also comprises the phases of:
detecting the torque data of the heat engine 9 of the vehicle, and
defining a maximum driving torque associated with the vehicle depending on the torque data.

The inverter of the perfected battery is configured to detect the torque data of the heat engine 9 through the motor-alternator 8, preferably for a length of time or a predefined distance traveled by the vehicle moved by the heat engine 9 only.

The maximum driving torque is determined through the driving torque data of the heat engine 9. Specifically, the torque data of the heat engine 9 comprise driving torque values generated by the heat engine 9 and by respective numbers of revolutions associated with the crankshaft of the heat engine 9. In actual facts, the torque data are representative of a motor curve of the heat engine 9. The method involves determining a maximum driving torque of the heat engine 9 depending on the torque data, i.e., the motor curve.

In detail, the phase of detecting the torque data of the heat engine 9 of the vehicle is carried out through the motor-alternator 8. In detail, the motor-alternator 8 is configured to carry out a dynamometer bench function during the phase of detecting the torque data of the heat engine 9. In other words, the torque data are acquired by means of the motor-alternator 8.

In addition, the method comprises the phase of regulating the delivery of electrical energy to the motor-alternator 8 depending on the torque data and on the maximum driving torque of the vehicle so that the motor-alternator 8 exerts a predefined driving torque on a transmission of the vehicle, e.g. through the crankshaft 9a of the heat engine 9. The delivery of electrical energy to the motor-alternator 8 is regulated in such a way that the driving torque generated by the motor-alternator 8, alone or added to the driving torque generated by the heat engine 9, is not greater than the maximum driving torque of the heat engine 9 depending on which the vehicle has been type-approved and sized in its components.

According to one aspect, the detected torque data of the heat engine 9 are representative of an instantaneous driving torque exerted by the heat engine 9 and of the number of revolutions associated with the heat engine 9, particularly with the crankshaft 9a of the heat engine 9.

Specifically, the phase of detecting the engine torque data is carried out for a predefined length of time or for a predefined distance traveled by the vehicle.

Preferably, the phase of detecting the vehicle torque data is carried out for a predefined distance of 50 km or more.

In one embodiment, the phase of detecting the engine torque data is carried out with a predefined frequency. In detail, the phase of detecting the engine torque data is carried out with a frequency of 10 Hz.

The method also comprises the phase of determining the predefined driving torque of the motor-alternator 8 as the difference between the maximum driving torque and the instantaneous driving torque exerted by the heat engine 9.

The phase of controlling the delivery of the electrical energy to the motor-alternator 8 is carried out depending on the predefined driving torque and on the number of revolutions associated with the heat engine 9.

According to one aspect, one or more of the phases in the described method are carried out by the inverter 6 or through the same.

1) Perfected battery (1) for vehicles, comprising:
a housing (2) bounded by a cover (3) and configured to receive inside:
a battery pack (4) configured to store electrical energy and power a motor-alternator (8) of said vehicle, and
a service battery (5) in electrical communication with said motor-alternator (8) and configured to:
store electrical energy, and
power the services of the vehicle,
an inverter (6) configured to:
put said batteries (5, 6) and said motor-alternator (8) in electrical communication with each other,
regulate the delivery of electrical energy from said battery pack (4) to said motor-alternator (8) so that the latter exerts a predefined driving torque on a transmission of the vehicle.

2) Perfected battery (1) according to claim 1, wherein said inverter (6) is configured to:
detect torque data of the heat engine (9) of the vehicle through said motor-alternator (8),
regulate the delivery of electrical energy to said motor-alternator (8) depending on the maximum driving torque of said heat engine (9).

3) Perfected battery (1) according to claim 1, wherein said inverter (6) is configured to detect the instantaneous driving torque exerted by the heat engine (9) on the transmission of the vehicle and the number of revolutions associated with the heat engine (9).

4) Perfected battery (1) according to claim 1, wherein said inverter (6) is configured to:
determine the predefined driving torque of the motor-alternator (8) as the difference between the maximum driving torque and the instantaneous driving torque exerted by the heat engine (9),
regulate the delivery of electrical energy to the motor-alternator (8) depending on the predefined driving torque and on the number of revolutions associated with the heat engine (9)

5) Perfected battery (1) according to claim 2, wherein said inverter (6) is configured to detect the torque data of the heat engine (9) for a predefined length of time or for a predefined distance traveled by the vehicle, preferably said predefined distance being 50 km or more.

6) Perfected battery (1) according to claim 1, wherein said battery pack comprises at least one supercapacitor (7) to store energy and to power said motor-alternator (8).

7) Perfected battery (1) according to claim 1, wherein:
the battery pack (4) supplies a voltage equal to 12V and/or an inrush current of between 800 A and 1300 A; and/or
the service battery (5) supplies a voltage of between 12 V and 48 V and/or a capacity of between 40 Ah to 250 Ah and/or an inrush current of between 500 Ah and 850 A; and/or
the housing (2) has a width of 175 mm, a height of 190 mm and a depth of between 200 mm and 400 mm.

8) Kit for the conversion of an endothermic vehicle to a hybrid vehicle comprising:
a motor-alternator (8) couplable to the heat engine (9) of the vehicle and configured to exert a predefined driving torque on a transmission of the vehicle;
a perfected battery (1) according to claim 1, the perfected battery (1) being in electrical communication with said motor-alternator (8).

9) Method for the conversion of an endothermic vehicle to a hybrid vehicle comprising the phases of:
replacing an original battery of the vehicle with the perfected battery (1) referred to claim 1 above,
replacing an original alternator of the vehicle with a motor-alternator (8) associable with the heat engine (9) and with the perfected battery and configured to exert a respective driving torque on a transmission of the vehicle,
detecting the torque data of the heat engine (9) of the vehicle, preferably through said motor-alternator (8),
defining a maximum driving torque associated with the vehicle depending on the torque data,
regulating the delivery of electrical energy to said motor-alternator (8) depending on the torque data and on the maximum driving torque of the vehicle so that said motor-alternator (8) exerts a predefined driving torque on a transmission of the vehicle.

10) Method according to claim 9, wherein the torque data of the heat engine (9) are representative of an instantaneous driving torque exerted by the heat engine (9) and of the number of revolutions associated with the heat engine (9), wherein:
the phase of detecting the torque data of the motor is carried out for a predefined length of time or for a predefined distance traveled by the vehicle, preferably the phase of detecting the torque data of the vehicle being carried out for a predefined distance of 50 km or more; and/or
the phase of detecting the torque data of the motor is carried out with a predefined frequency, preferably said predefined frequency being 10 Hz; and/or
determining the predefined motor torque of the motor-alternator (8) as the difference between the maximum motor torque and the instantaneous motor torque exerted by the heat engine (9), the phase of controlling the delivery of the electrical energy to the motor-alternator (8) being carried out depending on the predefined motor torque and on the number of revolutions associated with the heat engine (9).
